(19) United States
(12) Patent Application Publication
(10) Pub. No.: US 2002/0167824 A1
(43) Pub. Date: Nov. 14, 2002

(54) Power supply unit DC-DC conversion

(76) Inventors: Ulrich Boeke, Langerwehe (DE); Hubert Raets, Landgraaf (NL); Dirk Hente, Wuerselen (DE)

Correspondence Address: Philips Corporation, Electronics North America Corporation, 580 White Plains Road, Tarrytown, NY, 10591, US

(21) Appl. No.: 10/084,852

(22) Filed: Feb. 26, 2002

(30) Foreign Application Priority Data
Mar. 1, 2001 (EP) 01105063.0

(51) Int. Cl. H02M 3/335

(52) U.S. Cl. 363/24

(57) ABSTRACT

The invention relates to a power supply unit for direct current to direct current DC-DC conversion having multiple outputs. Such power converters comprise a DC-AC converter 100, a transformer 200 and a plurality of AC-DC converters 300-i i=1 . . . n each for generating an individual DC-output voltage Vi being provided to a respective load impedance 330-i. Lossy components in said transformer and said AC-DC converters cause undesired voltage drops causing undesired fluctuations of the DC-output voltages. A reduction of said fluctuations of said DC-output voltages is achieved by feeding-back the DC-output voltage of at least one AC-DC converter to said DC-AC converter. Starting from that prior art it is the object of the invention to improve a power supply unit for DC-DC conversion such that a more uniform sharing of the fluctuations of the output voltages is achieved easily and cheaply. This object is achieved according to the present invention by connecting an auxiliary impedance 340 in series to the load impedance connected to one of said AC-DC converters.

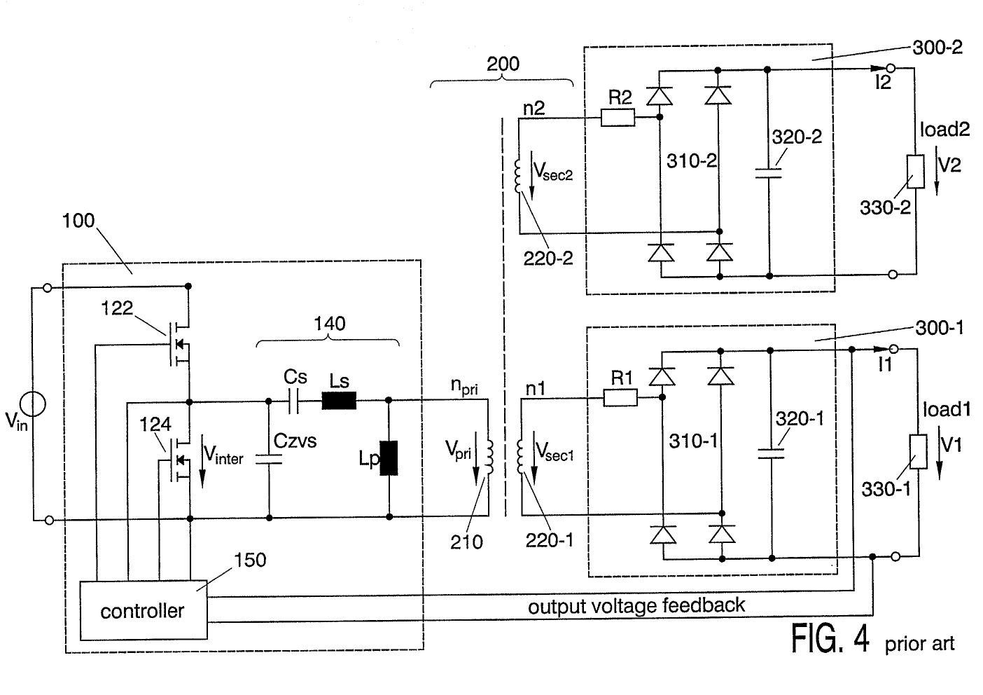

The invention relates to a power supply unit for direct current to direct current DC-DC conversion having multiple outputs as known in the art and illustrated in FIG. 4.

The power supply unit, in particular used for power supply of monitors, comprises a direct current to alternating current DC-AC converter 100 for converting a DC-input voltage Vin into a primary AC voltage Vpri. It further comprises a transformer 200 for transforming said primary AC voltage Vpri into a plurality of n secondary AC voltages Vsec i i=1 . . . n. Moreover, it comprises a plurality of AC-DC converters 300-i i=1 . . . n each for converting another one of said n secondary AC voltages into a DC-output voltage Vi i=1 . . . n for being provided to a respective load impedance 330-i i=1 . . . n.

In FIG. 4 and the other figures in said description the shown electrical components in said DC-AC-converter, in said transformer and in said AC-DC converters are considered to comprise only ideal components having no losses. The only exception from that assumption is made with regard to resistors Ri i=1 . . . n in the AC-DC converters 300-i; these resistors represent the losses occurring within said power supply unit, in particular within said transformer 200 and within said AC-DC converters 300-i, respectively. E.g. said resistors Ri represent transformer leakage inductances of the secondary windings ni, resistors of the secondary windings ni and of the rectifier diodes and resistances of DC filter inductors.

When a current Ii i=1 . . . n flows through said resistors Ri an undesired voltage drop is caused across said resistors Ri i=1 . . . n.

It is important to note that the DC-output voltage of any particular one of said AC-DC converters 300-i in general changes with the occurrence of said undesired voltage drops in not only the respective AC-DC converter which generates said DC-output voltage but also in any of the other AC-DC converters. This effect is known in the art as “cross-regulation” of converters with multiple outputs; in particular the DC-output voltage of the main converter 300-1 undesirably fluctuates in response to the occurrence of voltage drops in any of the AC-DC converters 300i i=1 . . . n.

In order to reduce said fluctuations in the DC-output voltage it is known in the art to feed back said DC-output voltage Vi to the DC-AC converter via a controller 150 as illustrated in FIG. 4. There the controller 150—which may be incorporated in the DC-AC converter or not—receives the output voltage V1 of the AC-DC converter 300-1 for generating control signals for controlling the DC-AC converter 100. The AC-DC converter 300-1 the DC-output voltage of which is fed-back to the controller 150 is hereinafter referred to as main AC-DC converter 300-1; to the contrary, the other AC-DC converters 300-2 . . . n are hereinafter referred to as auxiliary AC-DC converters.

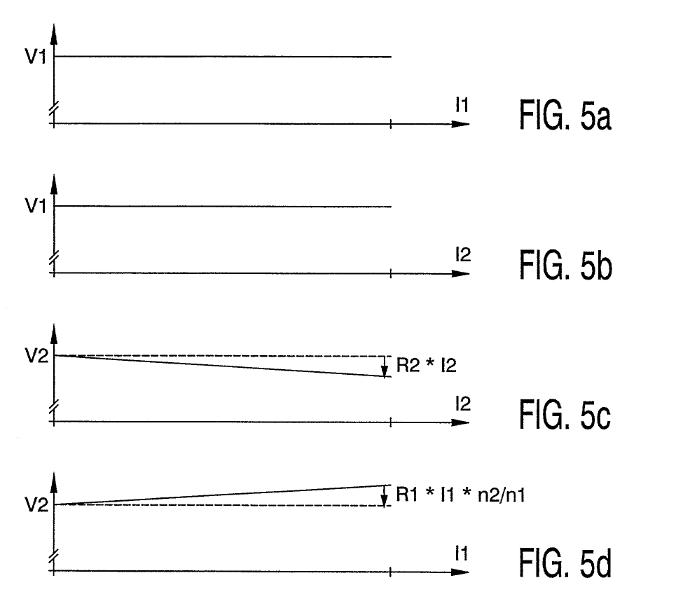

FIG. 5 illustrates the advantage of said feed-back of the output voltage. As can be seen in FIG. 5a and 5b the output voltage V1 of the main AC-DC converter 300-1 is independent from both currents I1 and I2 due to the described voltage control loop.

However, disadvantageously, in the embodiment shown in FIGS. 4 and 5 the negative effects of the undesired voltage drops have been completely shifted to the DC-output voltage V2 of the auxiliary AC-DC converter 300-2. More specifically, in that case the voltage V2 shows a reduction—corresponding to the voltage drop R2×I2—with regard to the output current I2 as shown in FIG. 5c ; said voltage drop in the auxiliary AC-DC converter 300-2 is not compensated by feeding back only the DC-output voltage of the main AC-DC converter 300-1.

Additionally, there occurs the voltage drop R1×I1×n2/n1 in the main converter 300-1—with regard to the output current I1. This voltage drop is compensated in the DC-output voltage V1 of the main converter due to the control loop represented by the feed-back of the DC-output voltage; however, disadvantageously the transformer voltage at the input of the auxiliary converter 300-2 is increased due to said voltage drop resulting in an undesired increase of the voltage V2 according to R1×I1×n2/n1.

Regarding FIG. 5 it can be seen that the output voltage V1 is controlled very well, i.e. said voltage V1 is kept constant regarding I1 and I2 due the feed-back of said voltage V1. To the contrary, there is no control provided to the voltage V2 resulting in the undesired fluctuations of V2, the fluctuations having different algebraic signs as illustrated in FIGS. 5c and 5d.

In order to achieve another sharing of the fluctuations over the available output voltages Vi there are several approaches known in the art.

A first approach is known from U.S. Pat. No. 4,628,426 which discloses a dual output DC-DC converter with independently controllable output voltages. Said DC-DC converter comprises a single DC-AC power switching converter feeding two DC load circuits from two transformer secondary windings. A first secondary winding is tightly coupled to the primary and the DC output voltage of the first DC load circuit following said first secondary winding is controlled by using pulse-width-modulation. The other secondary winding is loosely coupled to the primary winding so that its leakage inductance resonates with a second capacitor such that the DC-output voltage of the second DC-load impedance converter following said other secondary winding is controlled by converter frequency adjustment.

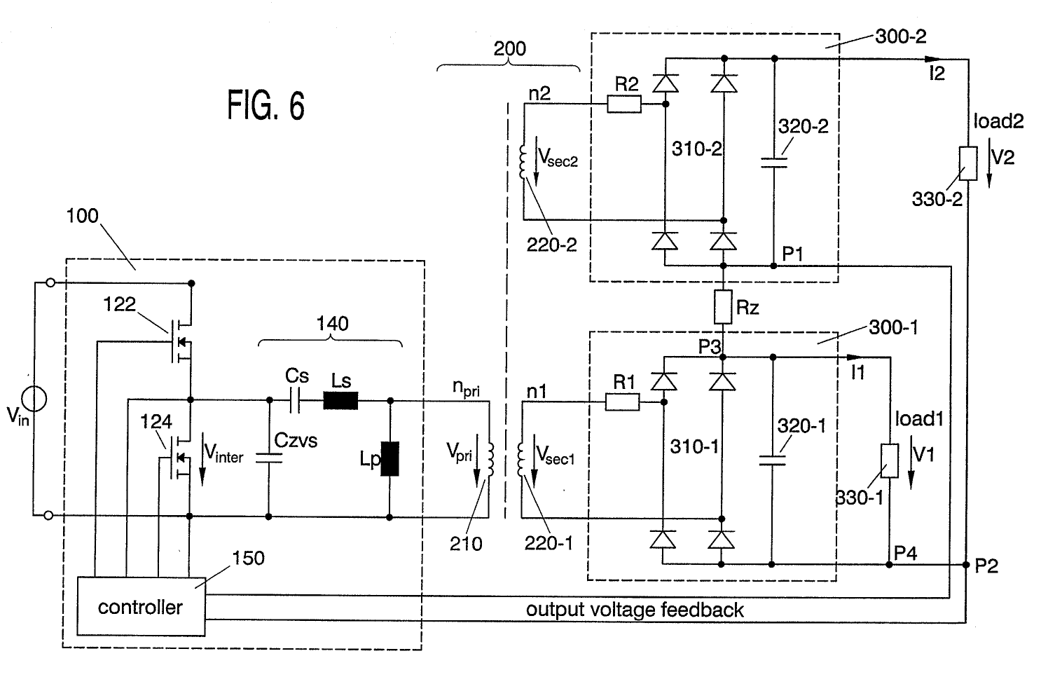

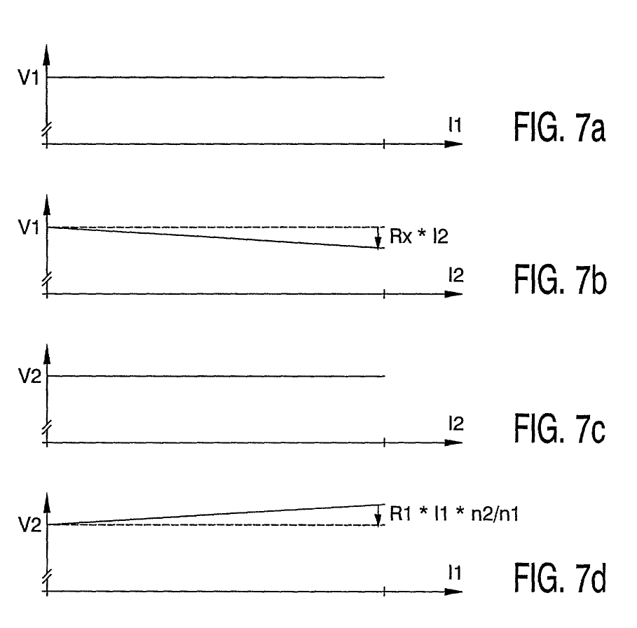

A second approach is known from U.S. Pat. No. 4,660,136 and illustrated in FIGS. 6 and 7. The power supply unit shown in FIG. 6 substantially only differs from the power supply unit shown in FIG. 4 in the feed-back voltage. According to that approach the feed-back voltage does not correspond to the output voltage of one of said AC-DC converters but corresponds to the potential difference between points P1 and P2 as illustrated in FIG. 6. Moreover, point P1 is connected via a resistor Rz to the potential point P3 of the main converter 300-1 and point P2 is connected directly with potential point P4 of the main converter.

Rz is preferably calculated according to the following equation:

R2=n2/n1·(R1+Rz)

The operation of the circuit according to FIG. 6 is illustrated in FIG. 7. It can be seen now that on one hand the voltage V2 is independent of I2, i.e. the fluctuations of V2 caused by I2 in the circuit shown in FIG. 4 are deleted; however, V2 still shows fluctuations represented by the term R1×I1×n2/n1 with regard to current I1 and having a positive sign. Moreover, V1 now is still independent of I1 but shows fluctuations represented by R2×I2 caused by I2. The voltage drop R1×I1 is compensated, see FIG. 7a by the voltage control loop shown in FIG. 6.

Expressed in other words, a sharing of the fluctuations of V2 has taken place in comparison to the circuit shown in FIG. 4 such that these fluctuations have been shared to the outputs of the auxiliary as well as of the main converter 300-i.

However, the circuit according to FIG. 6 has the disadvantages that all auxiliary output voltages must be greater than the main output voltage and that the output voltage can not be isolated from each other. All output voltages must be connected to the same ground line in order to achieve that all auxiliary output currents generating a voltage drop at Rz. Moreover, it is not appreciated to have dependencies of the DC-output voltages from the currents flowing in adjacent AC-DC converters V1(I2) or V2(I1) and of different signs.

Starting from that prior art it is the object of the invention to improve a power supply for DC-DC conversion such that a more uniform sharing of the fluctuations of the output voltages is achieved easily and cheaply.

This object is solved by the subject matter of claim 1 in that in the power supply unit described above an auxiliary impedance is connected in series to the load impedance connected to the main AC-DC converter.

That circuit design according to the present invention results in a more uniform sharing of said fluctuations over said DC-output voltages. Said uniform voltage sharing is represented by different advantageous aspects.

According to a first aspect the fluctuations of the DC output voltages of the AC-DC converters are only dependent on the currents of the respective converters, i.e. V1(I1) and V2(I2). Expressed in other words, the DC output voltages Vi are independent of the currents flowing in adjacent converters.

According to a second advantageous aspect the fluctuations of all DC outputs have the same algebraic sign.

According to a third advantageous aspect there is no DC-output voltage of an AC-DC converter having un-proportional high fluctuations or having no fluctuations. To the contrary the fluctuations are shared to all available outputs each having moderate fluctuations. Advantageously this sharing is achieved without providing any electrical connection between the different AC-DC converters except the transformer.

Providing the auxiliary impedance in a series connection to the load impedance of the main converter is inexpensive and can be achieved very easily.

According to a first embodiment of the invention a voltage divider comprising a series connection of at least two dividing impedances is connected in parallel to the load impedance connected to the main AC-DC converter and the feed-back voltage is tapped across said auxiliary and at least one of said dividing impedances. When evaluating such a feed-back voltage the losses in the impedance are reduced.

Further advantageous embodiments of the invention are subject matter of the dependent claims or of the use claim.

In the following preferred embodiments of the invention are described in more detail by referring to the following accompanying figures, wherein:

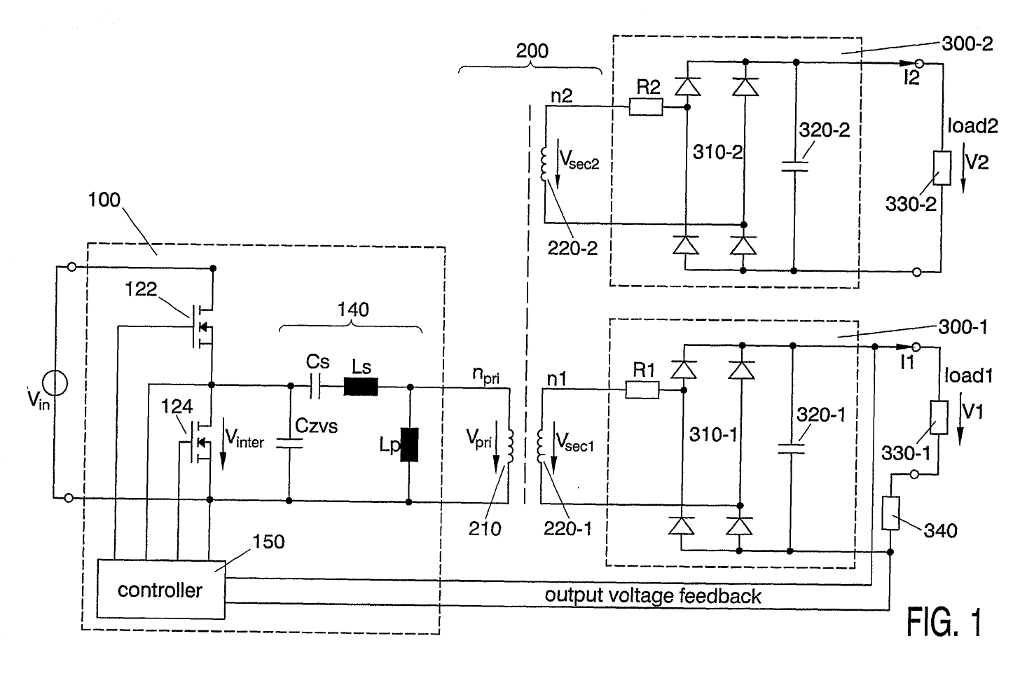

FIG. 1 shows a first embodiment of the power supply unit according to the present invention;

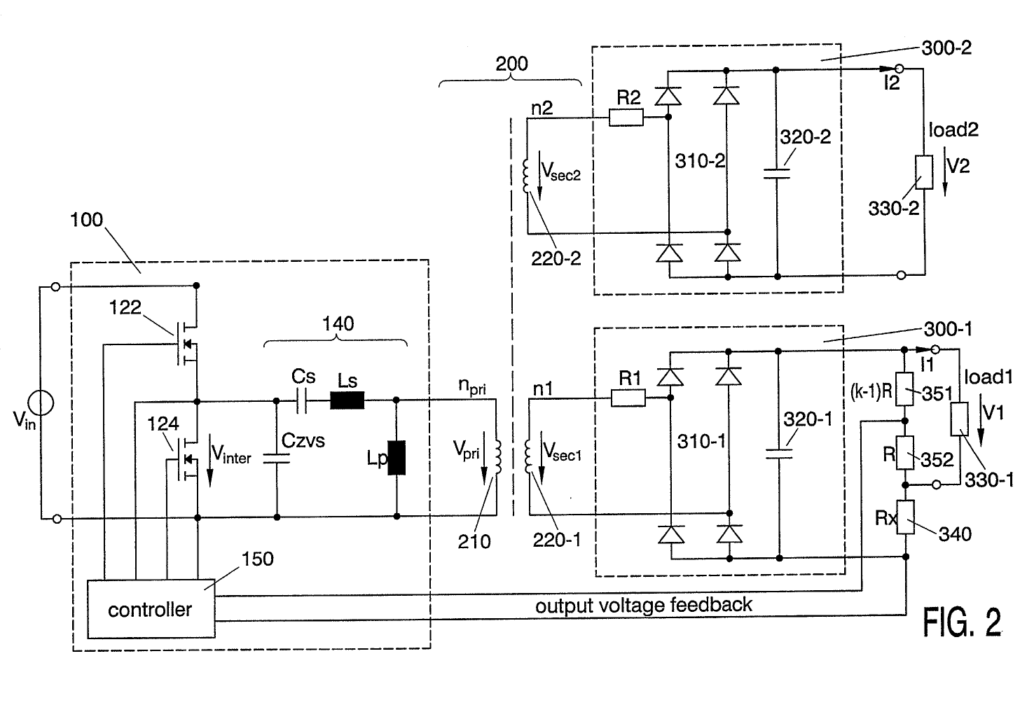

FIG. 2 shows a second embodiment of the power supply unit according to the present invention;

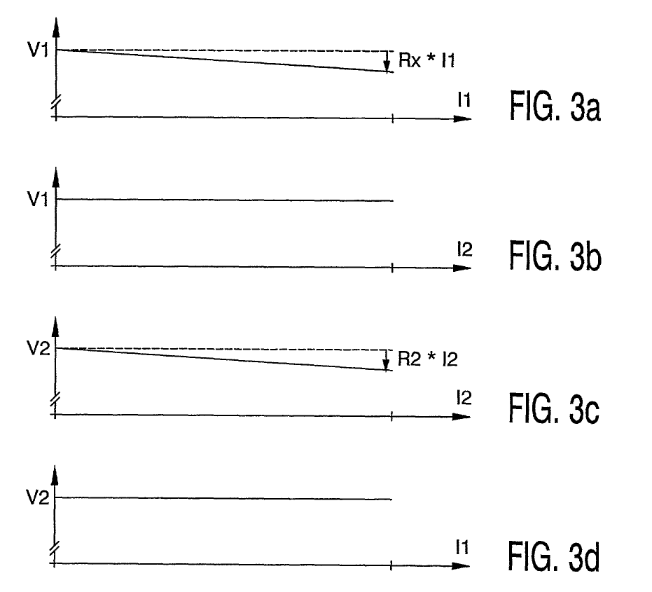

FIGS. 3 a-d illustrate the fluctuations of different DC-output voltages of the second embodiment of the power supply unit;

FIG. 4 shows a power supply unit known in the art;

FIGS. 5 a-d illustrate the fluctuations of different DC-output voltages of the power supply unit shown in FIG. 4;

FIG. 6 shows another power supply unit known in the art; and

FIGS. 7 a-d illustrate the fluctuations of different DC-output voltages of the power supply unit shown in FIG. 6.

FIG. 1 shows a first embodiment of the power supply unit according to the present invention. Said unit substantially corresponds to the power supply unit described above by referring to FIG. 4. Thus, identical components are hereinafter referred to by the same reference numerals.

In the following the hardware of the power supply unit according to FIG. 1, shall be explained in more detail.

The DC-AC converter 100 of the power supply unit comprises switches 122, 124 for dividing the input voltage Vin into an intermediate voltage Vinter being appropriate for being input to a successive resonance tank circuit 140. Said resonance tank circuit 140 is used for generating said primary AC voltage Vpri. In FIG. 1 said circuit is embodied as π-circuit wherein a first vertical branch comprises a capacitor Czvs, the horizontal branch comprises a series connection of a second capacitor Cs and a coil Ls and wherein the second vertical branch comprises a second coil Lp. In difference to FIG. 1 the resonance tank circuit 140 may comprise different arrangements of coils Ls, Lp and capacitors Cs, Czvs in general referred to as LC-, LCC-, LLC-, LLCC-type halfbridge or fullbridge converters.

The transformer 200 has one primary coil 210 having npri windings and has n secondary coils 220-i, i=1 . . . n having individual windings ni i=1 . . . n, respectively. Said secondary coils serve for generating said secondary voltages Vseci i=1 . . . n.

Each of said secondary coils is followed by one of said AC-DC converters 300-i i=1 . . . n for generating a DC-output voltage respectively. Said AC-DC converters respectively comprise a rectifier, preferably a fullbridge-diode-rectifier 310-i i=1 . . . n, and a capacitor 320-i i=1 . . . n which is connected in parallel behind said rectifier.

The DC-output voltages Vi respectively drop across said capacitors 320-i i=1 . . . n and are output to individual load impedances 330-i, i=1 . . . n. The DC-output voltages Vi generated by one power supply unit according to the present invention e.g. for computer monitors reach from 5 V to 26 KV within one power supply unit.

In difference to the power supply unit depicted in FIG. 4 the power supply unit according to FIG. 1 comprises an auxiliary impedance 340, preferably a resistor, which is connected in series to the load impedance 330-1 at the output of the main AC-DC-converter 300-1. The feed-back voltage in FIG. 1 represents the DC-output voltage V1 plus the voltage drop across the auxiliary impedance 340.

In that case due to the provision of the additional auxiliary impedance 340 the voltage control loop enables an optimal compensation for the DC-output voltages of the AC-DC converter 300-i, such that the fluctuations thereof are all kept on a moderate level because they are uniformly shared to all available outputs. Due to the auxiliary impedance, in particular when the magnitude Rx thereof is chosen to Rx=R1, wherein R1 represents the magnitude of losses in said power supply unit, in particular in said secondary coil 220-1 and the main AC-DC converter 300-1, the voltage control loop does at least partly compensate for the internal voltage drop R1×I1 in the AC-DC converter 300-1. As a consequence, the DC-output voltages Vi in the main and in the auxiliary AC-DC converters are not or at least less influenced by the output current I1 of the main AC-DC converter 300-1 compared to the operation without this additional impedance 340.

FIG. 2 shows a second embodiment of the power supply unit according to the present invention. It differs from the first embodiment shown in FIG. 1 in that a voltage divider comprising a series connection of at least two dividing impedances 351, 352 is connected in parallel to the load impedance 330-1 connected to the main AC-DC converter 300-1 and that the feed-back voltage is tapped across said auxiliary and at least one of said dividing impedances 340, 352.

By using the voltage divider the value Rx of the auxiliary impedance 340 is reduced in comparison to the value of the resistor R1 by the ratio of the voltage divider k according to the following equation:

Rx=/k·R1

By measuring the feed-back voltage for the voltage control loop via the voltage divider 351, 352 the losses represented by the auxiliary impedance 340 are reduced.

FIG. 3 shows the positive effects in the operation of the power supply unit according to the present invention.

According to FIG. 3a the DC-output voltage V1 of the main AC-DC converter 300-1 is only reduced by the voltage drop R1×I1; the voltage drop R2×I2 does not influence V1, see FIG. 3b. V2 is not influenced by the voltage drop R1×I1, see FIG. 3c and 3d; however V2 is influenced by the voltage drop R2×I2, see FIG. 3c. The fluctuations of V1 and V2 have the same algebraic sign, see FIG. 3a) and 3c). Neither voltages V1 and V2 show no or un-proportional high fluctuations with the result that a moderate sharing of the fluctuations of the DC-output voltages is achieved.

1. A power supply unit for direct current to direct current DC-DC conversion, comprising:
a direct current to alternating current DC-AC converter (100) for converting a DC-input voltage (Vin) into a primary AC voltage (Vpri);
a transformer (200) for transforming said primary AC voltage (Vpri) into a plurality of n secondary AC voltages (Vseci); and
a plurality of AC-DC converters (300-i, i=1 . . . n) each for converting one of said n secondary AC voltages (Vseci) respectively, into a DC-output voltage being provided to a load impedance (330-i i=1 . . . n); wherein only the DC-output voltage of a main one of said AC-DC converters (300-1) is fed back to a controller (150) of said DC-AC converter (100);
characterized in that an auxiliary impedance (340) is connected in series to the load impedance (330-1) connected to the main AC-DC converter (300-1).

2. The power supply unit according to claim 1, characterized in that a voltage divider comprising a series connection of at least two dividing impedances (351, 352) is connected in parallel to the load impedance (330-1) connected to the main AC-DC converter (300-1) and that the feed-back voltage is tapped across said auxiliary (340) and at least one of said dividing impedances (352).

3. The power supply unit according to claims 1 or 2, characterized in that the value Rx of the auxiliary impedance (340) is calculated according to:
Rx=1/k·R1
wherein:
k: is the dividing ratio of the voltage divider; and
R1: is the magnitude of an impedance representing undesired losses in the power supply unit and causing the undesired voltage drop therein.

4. The power supply unit according to one of claims 1 to 3, characterized in that said DC-AC converter (100) comprises the following components:
a resonance tank circuit (140) for generating said primary AC-voltage (Vpri);
controllable switches (122, 124) for dividing said input voltage (Vin) into an intermediate voltage (Vinter) in response to individual control signals; said intermediate voltage representing the input voltage of said resonance tank circuit (140); and
the controller (150) for generating said control signals in response to said feed-back voltage.

5. The power supply unit according to claim 4, characterized in that the resonance tank circuit (140) is embodied as LC-, LLC-, LCC- or as LLCC type circuit.

6. The power supply unit according to claim 4, characterized in that said DC-AC converter (100) comprises four controllable switches forming a full bridge.

7. The power supply unit according to one of claims 1 to 5, characterized in that each AC-DC-converter (300-i) comprises a rectifier (310-i) and a capacitor (320-i) being connected in parallel behind said rectifier for generating said DC-output voltage, respectively.

8. The power supply unit according to claim 7, characterized in that each of said rectifiers (310-i) is embodied as fullbridge-diode-rectifier, respectively.

9. Monitor comprising a power supply unit according to one of claims 1 to 8.
